(19) United States
(12) Patent Application Publication
(10) Pub. No.: US 2026/0356430 A1
(43) Pub. Date: Nov. 12, 2026

(54) VEHICLE PROTECTION ASSEMBLIES

(71) Applicant: Rivian IP Holdings, LLC, Irvine, CA (US)

(72) Inventors: Sharbel ELKANTATI, Windsor (CA); Tripur Udhav MAHAJAN, Irvine, CA (US); Adam Richard BALLARD, Corona, CA (US); Ryan ARENS, Irvine, CA (US)

(21) Appl. No.: 19/271,110

(22) Filed: Jul. 16, 2025

Related U.S. Application Data
(63) Continuation-in-part of application No. 19/201,832, filed on May 7, 2025.

(51) Int. Cl. B62D 21/10; B62D 29/04

(52) U.S. Cl. CPC B62D 21/10; B62D 29/041

(57) ABSTRACT

Vehicle protection assemblies and methods of manufacturing vehicle protection assemblies are provided. Embodiments include a vehicle protection assembly with a composite base, a first organo sheet, and a second organo sheet. Embodiments include the composite base having a first side and a second side that is opposite the first side. Embodiments include the first organo sheet bonded to the first side of the composite base. Embodiments include the second organo sheet bonded to the second side of the composite base.

### CROSS-REFERENCE TO RELATED APPLICATIONS

This application is a continuation-in-part of U.S. Non-Provisional Application No. 19/201,832, filed May 7, 2025, the contents of which are incorporated by reference herein in its entirety.

### INTRODUCTION

The present disclosure relates to vehicles. More particularly, the present disclosure relates to vehicle protection assemblies.

### SUMMARY

Embodiments of the present disclosure advantageously provide vehicle protection assemblies and methods for manufacturing vehicle protection assemblies.

In certain embodiments, a vehicle protection assembly is provided. The vehicle protection assembly includes a composite base having a first side and a second side that is opposite the first side, a first organo sheet bonded to the first side of the composite base, and a second organo sheet bonded to the second side of the composite base.

In certain embodiments, another vehicle protection assembly is provided. The vehicle protection assembly includes an aluminum base, a first organo sheet having a first side and a second side, the first side of the first organo sheet coupled to the aluminum base, a second organo sheet coupled to the second side of the first organo sheet, and an injection molded material bonding the second organo sheet to the first organo sheet.

In certain embodiments, a method of manufacturing a vehicle protection assembly is provided. The method includes heating a stack comprised of an aluminum base, a first organo sheet, and a second organo sheet, placing the stack in a mold cavity, and injecting an injection molded material into the mold cavity, wherein the injection molded material bonds the second organo sheet to the first organo sheet.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1A shows an isometric perspective view an example vehicle, according to certain embodiments.

FIG. 1B shows an isometric perspective view of an example chassis of the vehicle shown in FIG. 1A, according to certain embodiments.

FIG. 2A shows an exploded isometric perspective view of an example vehicle protection assembly for an underside of the chassis shown in FIG. 1B, according to certain embodiments.

FIG. 2B shows a cross-sectional side view of an organo sheet of the vehicle protection assembly of FIG. 2A being bonded to a composite base, according to certain embodiments.

FIGS. 2C-2D show different isometric perspective views of the vehicle protection assembly shown in FIG. 2A, according to certain embodiments.

FIG. 3A shows a top view of the vehicle protection assembly shown in FIGS. 2C-2D with reinforcement structures having different geometric arrangements, according to certain embodiments.

FIG. 3B shows a top view of the vehicle protection assembly shown in FIGS. 2C-2D with reinforcement structures having different densities, according to certain embodiments.

FIG. 3C shows a top view of the vehicle protection assembly shown in FIGS. 2C-2D with reinforcement structures having different thicknesses, according to certain embodiments.

FIG. 4 shows an exploded isometric perspective view of modules of the vehicle protection assembly shown in FIGS. 2C-2D, according to certain embodiments.

FIGS. 5A-5B show different views of a stack of another example vehicle protection assembly for the chassis shown in FIG. 1B, according to certain embodiments.

FIGS. 6A-6B show different isometric perspective views of an example vehicle protection assembly including the stack shown in FIGS. 5A-5B, according to certain embodiments.

FIG. 7A shows a magnified isometric perspective view of the vehicle protection assembly shown in FIGS. 6A-6B, according to certain embodiments.

FIGS. 7B-7D show different isometric cross-sectional views of the vehicle protection assembly shown in FIG. 7A, according to certain embodiments.

FIG. 8 is a flow diagram of a technique for manufacturing a vehicle protection assembly, according to certain embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

It will be readily understood that the components of the embodiments as generally described herein and illustrated in the appended Figures can be arranged and designed in a wide variety of different configurations. Thus, the following more detailed description of various embodiments, as represented in the Figures, is not intended to limit the scope of the present disclosure but is merely representative of various embodiments. While the various aspects of the embodiments are presented in the Figures, the Figures are not necessarily drawn to scale unless specifically indicated.

Electric vehicles are powered by batteries that are typically located near the bottom of the vehicle. Protecting the battery from external conditions and/or impacts is important for a variety of purposes, such as to prevent deformation or intrusion of the battery, which can lead to overheating or thermal runaway, to shield the battery from external temperature swings that can affect performance and charging efficiency, and/or for other longevity purposes. Existing techniques for protecting a battery of an electric vehicle generally involve a vehicle protection assembly, such as a skid plate, which is often a large metal assembly secured to an underside of the electric vehicle.

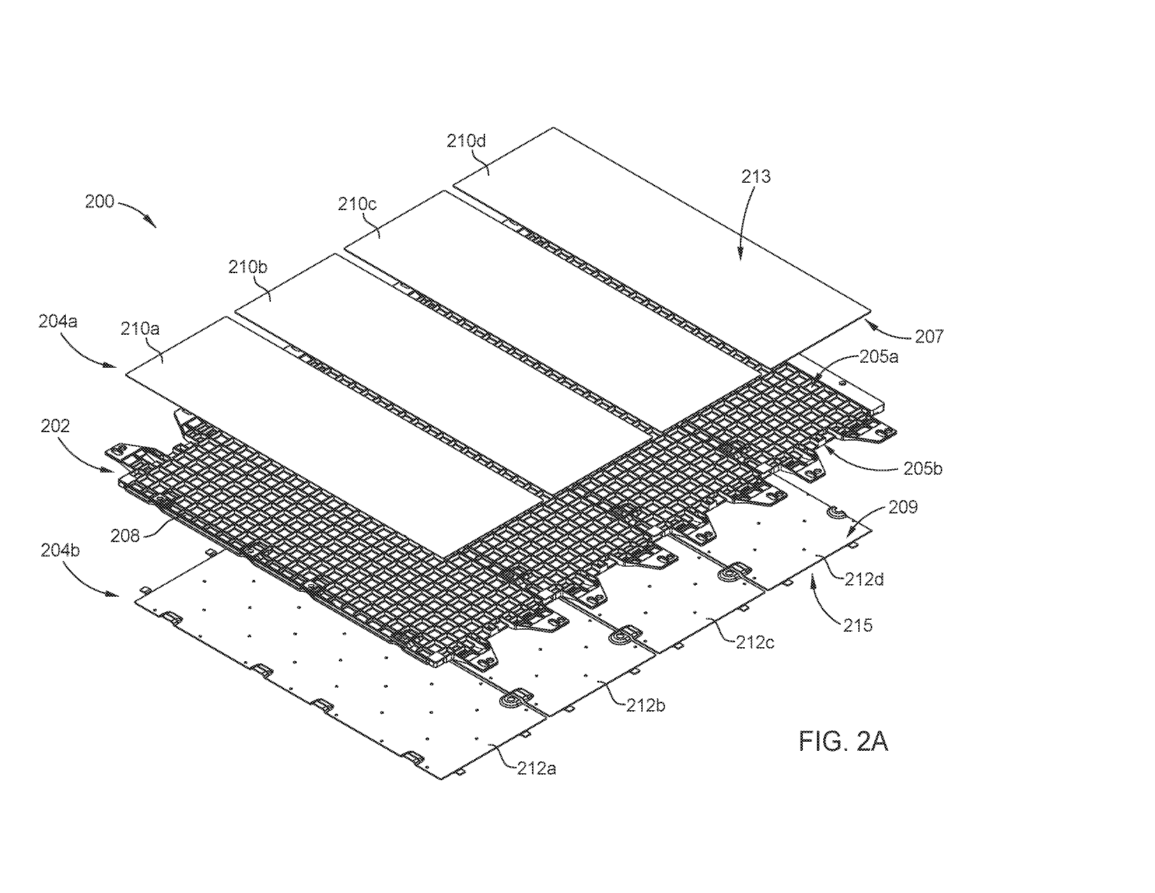

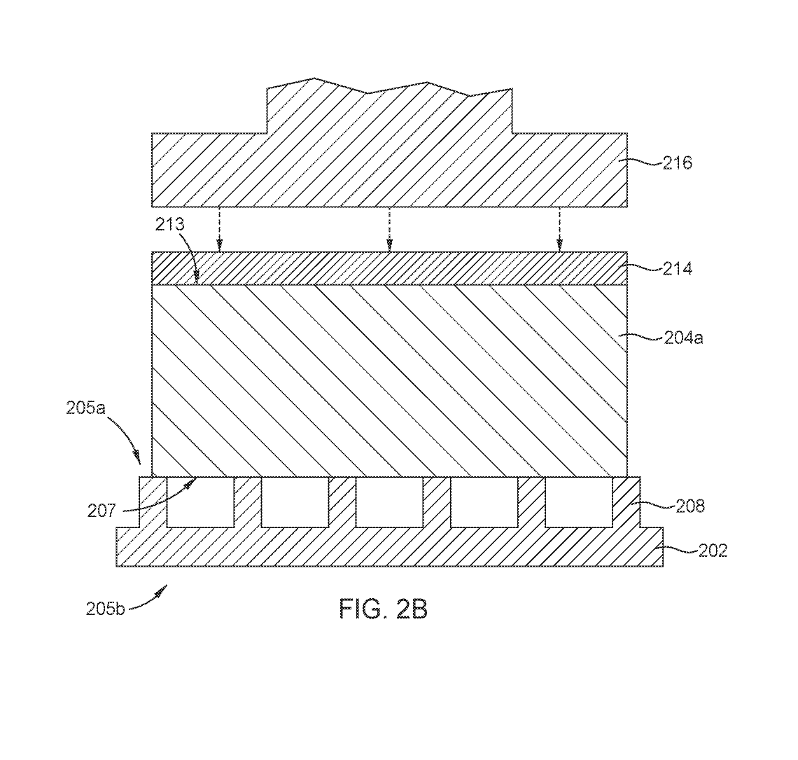

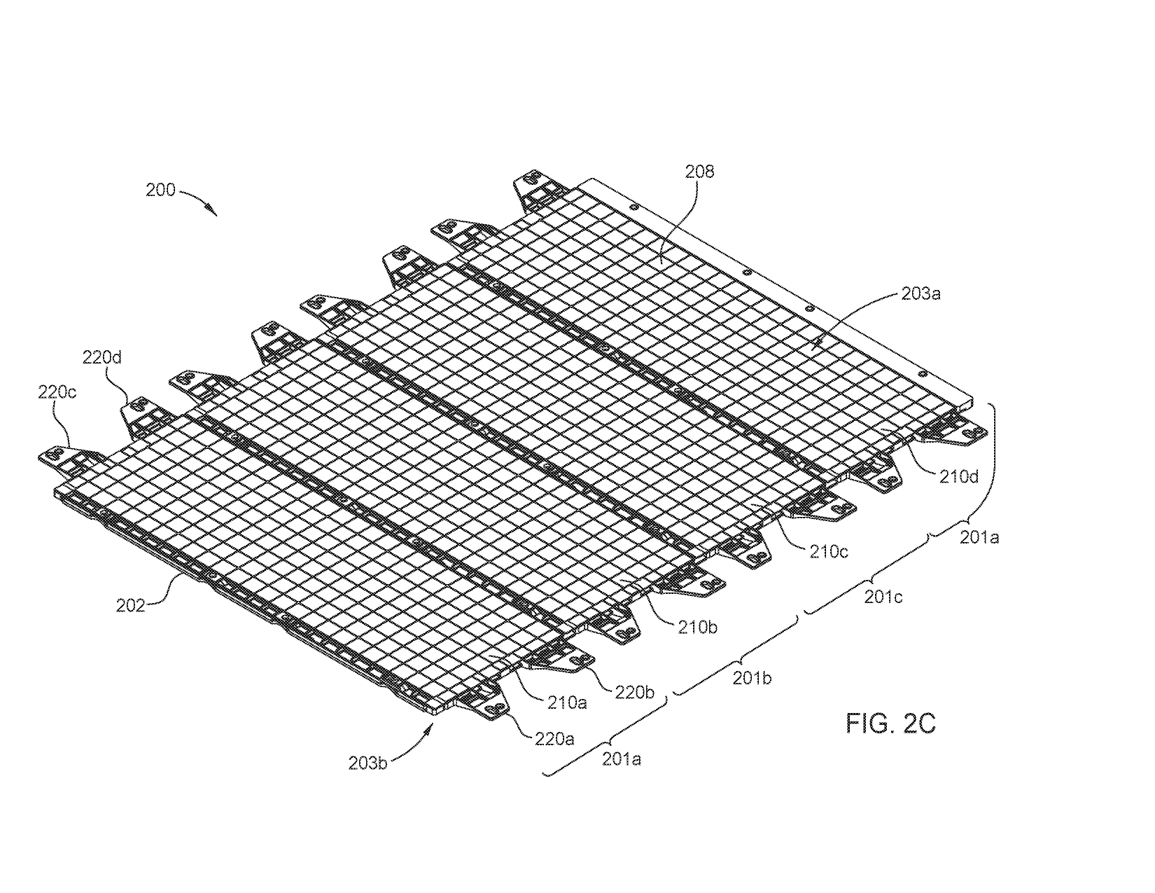

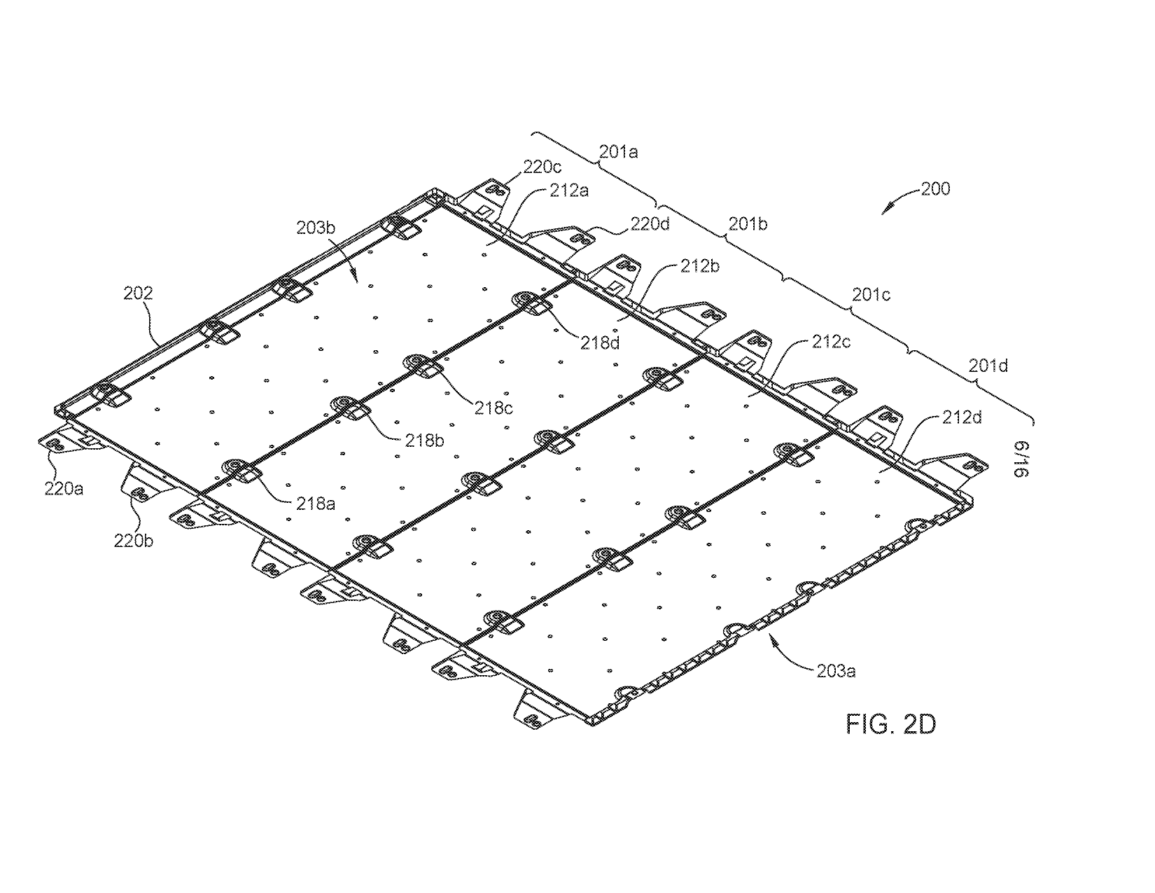

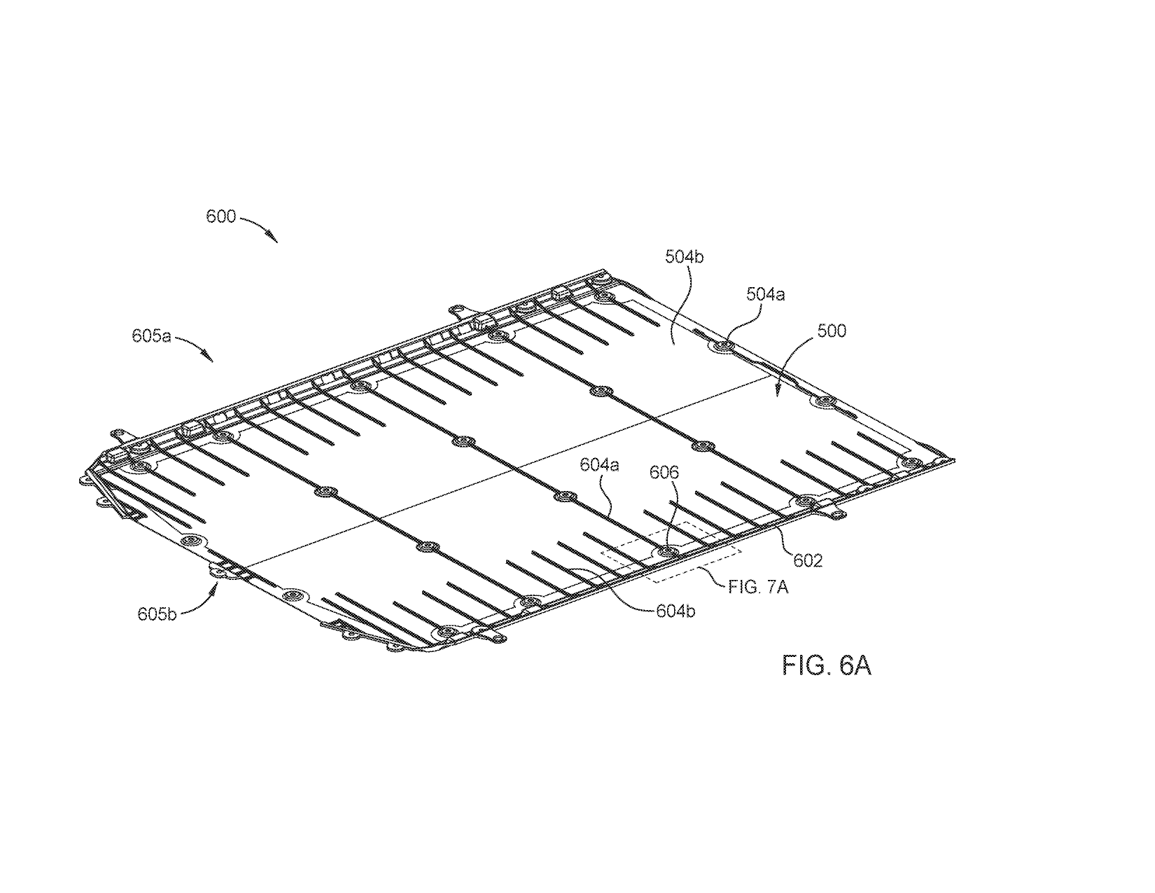

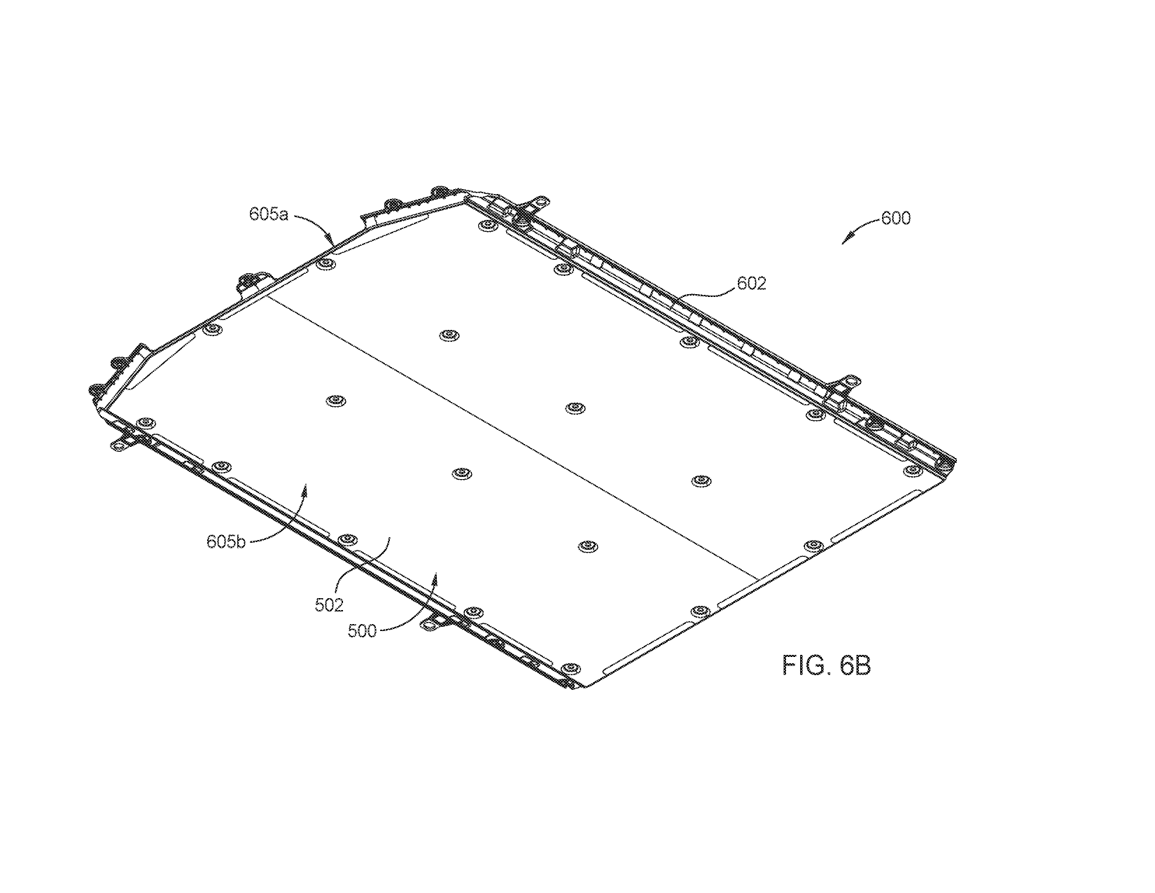

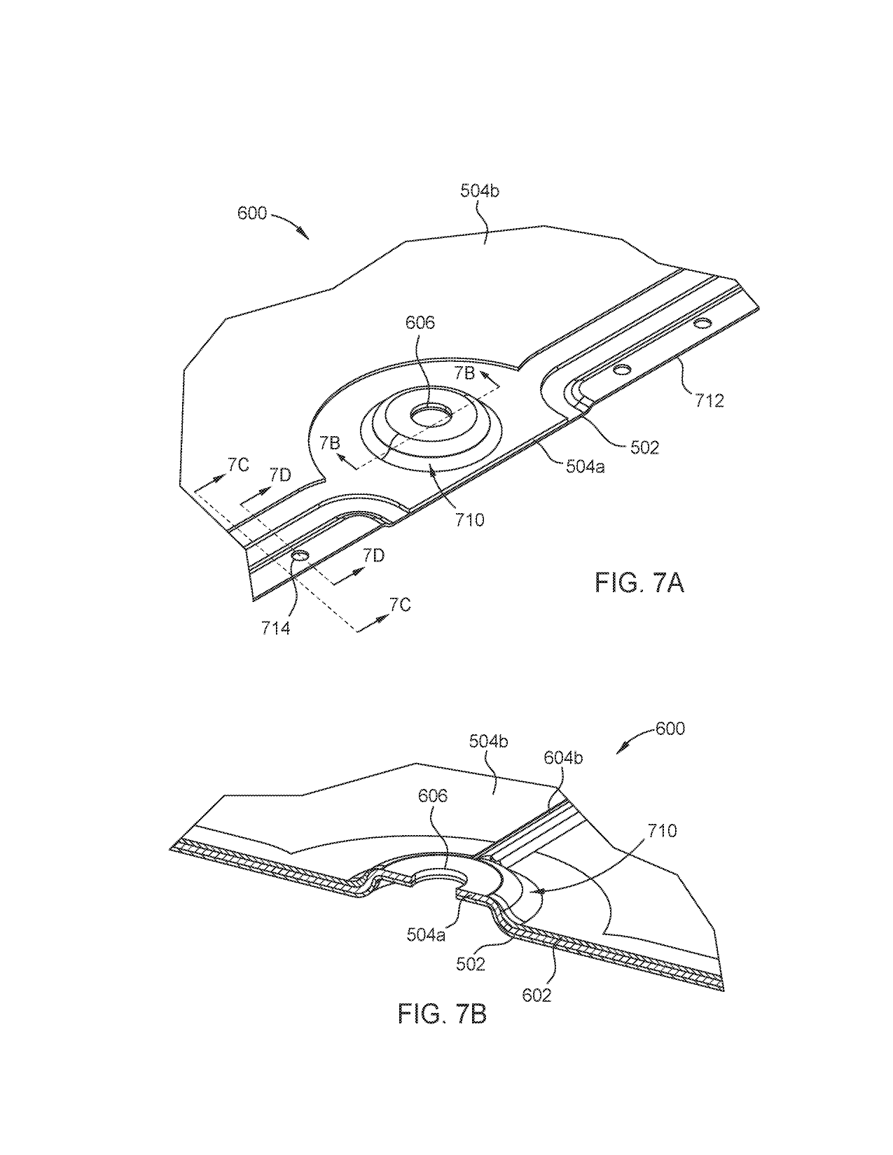

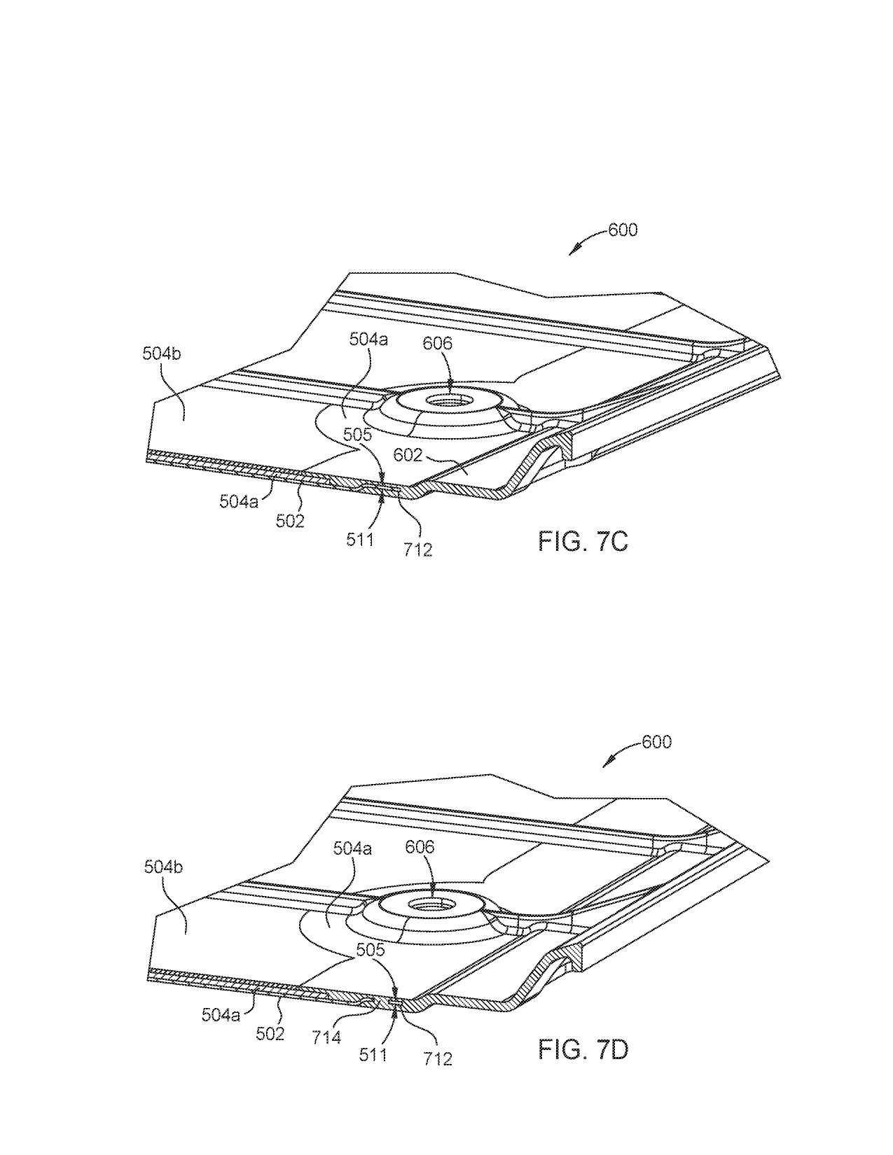

Aspects of the present disclosure provide improved vehicle protection assemblies that combine organo sheet(s) with a composite and/or aluminum base. For example, as described in more detail below with respect to FIGS. 2A-2D, one vehicle protection assembly includes two organo sheets that are bonded to a composite base having reinforcement structures, the vehicle protection assembly providing improved mechanical performance (e.g., due to increased stiffness, reduced likelihood of delamination, and greater joint strength), as well as simplified manufacturing and servicing processes (e.g., due to modularity). As described in more detail below with respect to FIGS. 6A-6B and 7A-7D, another vehicle protection assembly includes two organo sheets that are bonded to an aluminum base, the vehicle protection assembly also providing improved mechanical performance, as well as reduced manufacturing costs (e.g., due to injection molding). In various embodiments, the vehicle protection assemblies may be representative of a skid plate or an underbody component for protecting the battery of the electric vehicle.

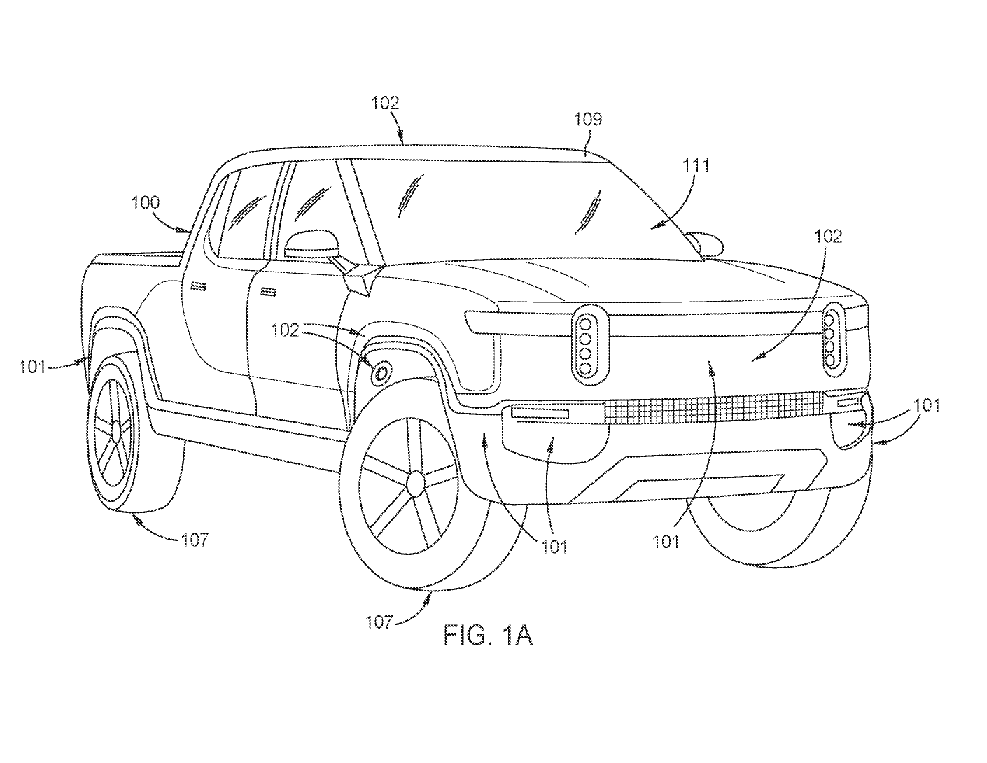

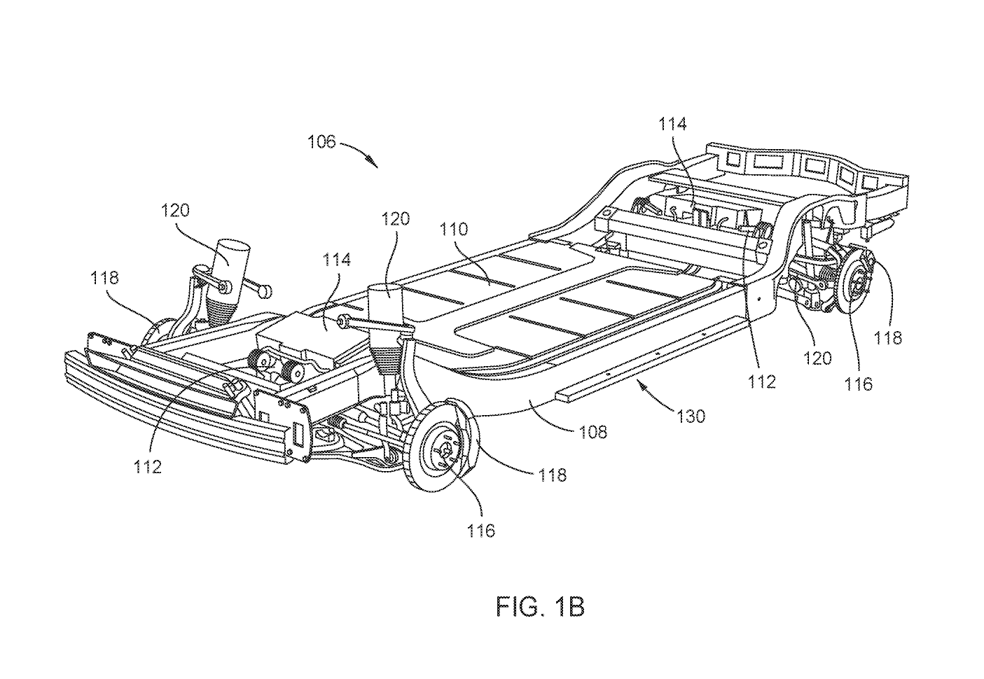

FIG. 1A is a schematic perspective view an example vehicle 100, according to certain embodiments. The vehicle 100 may include multiple sensors 101 and/or multiple cameras 102. The vehicle 100 includes one or more wheel modules 107. The vehicle 100 is an automotive vehicle. In the implementation shown in FIG. 1A, the vehicle 100 is a truck, such as an electric truck. The present disclosure contemplates that the subject matter described herein can be used in any other type of vehicle having any numbers of wheels, such as vans, internal combustion vehicles, and/or sport-utility vehicles (SUVs). The vehicle 100 includes a view panel 111 mounted to a vehicle body 109 of the vehicle 100.

In the embodiment of FIG. 1A and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

FIG. 1B is a schematic perspective view of an example chassis 106 of the vehicle 100 shown in FIG. 1A, according to certain embodiments. The chassis 106 includes a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

At an underside 130 of the chassis 106, a vehicle protection assembly, such as one of the vehicle protection protections assemblies described herein, is secured to the chassis 106. The vehicle protection assembly is disposed over the battery 110 and protects the battery 110 from external impacts and debris. Adequate protection of the battery 110 is important for decreasing risk of failure, improving longevity, and overall performance of the battery 110, as well as the vehicle 100.

FIG. 2A shows an exploded isometric perspective view of an example vehicle protection assembly 200 for the underside 130 of the chassis 106 shown in FIG. 1B, according to certain embodiments. The vehicle protection assembly 200 shown in FIG. 2A includes a composite base 202 as well as a first organo sheet 204a and a second organo sheet 204b (organo sheets 204a-b).

The composite base 202 is generally made of a combination of one or more fibers (e.g., a thermoplastic polymer) and a resin matrix for holding the fiber(s) together. Examples of fiber(s) include carbon fibers, glass fibers, and/or other suitable fibers. Examples of the resin matrix include thermoset resins (e.g., unsaturated polyester resin (UPR), epoxy resin, vinyl ester resin, etc.), thermoplastic resins (e.g., polypropylene (PP), polyamide (PA), etc.), and/or other suitable resins. In various embodiments, the composite base 202 has a thickness of 1 millimeters (mm) to 6 mm (e.g., 1.5 mm to 5.5 mm, 2 mm to 5 mm, or 2.5 mm to 5 mm). In certain embodiments, the thickness of the composite base 202 is greater than a thickness of the first organo sheet 204a and a thickness of the second organo sheet 204b.

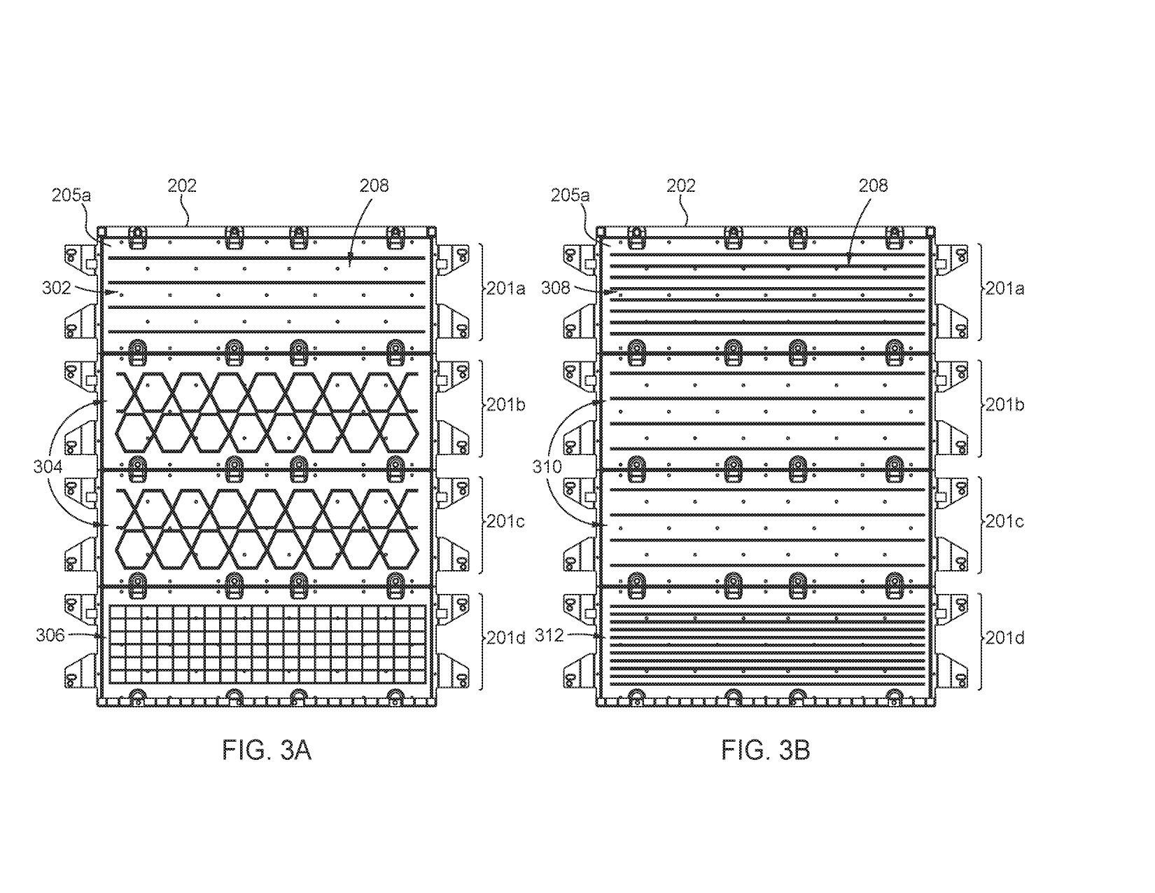

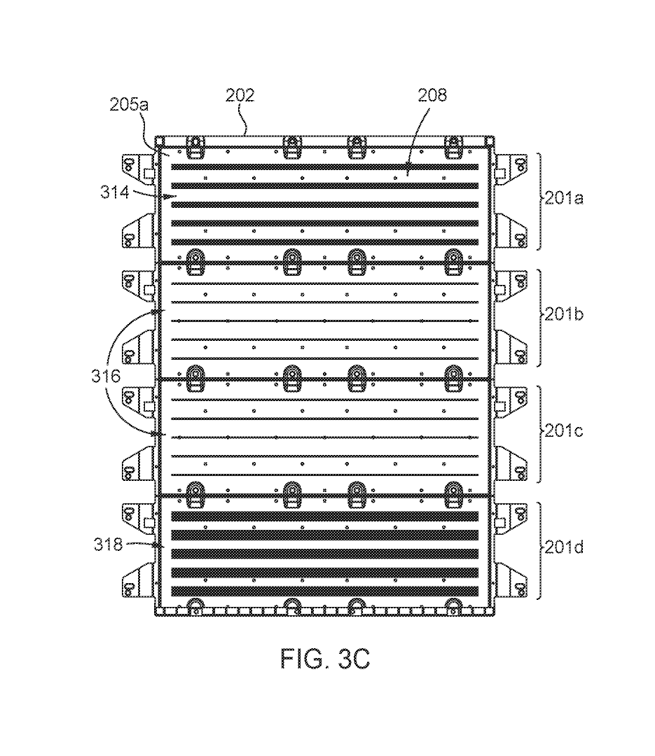

As shown in FIG. 2A, the composite base 202 includes a first side 205a and a second side 205b (sides 205a-b). The first side 205a faces the first organo sheet 204a and the second side 205b, which is opposite the first side 205a, faces the second organo sheet 204b. The composite base 202 further includes a plurality of reinforcement structures 208 formed on the first side 205a. The reinforcement structures 208 extend from the first side 205a towards the first organo sheet 204a, and have a height of 1 mm to 5 mm (e.g., 1.2 mm to 4.8 mm, 1.4 mm to 4.6 mm, or 1.6 mm to 4.4 mm). The reinforcement structures 208 are described in further detail with respect to FIGS. 3A-3C.

The organo sheets 204a-b are generally made of a combination of one or more fibers, which can be woven or laminated, and a thermoplastic matrix for holding the fiber(s) together. In other words, the organo sheets 204a-b can be made of multiple unidirectional endless fiber tapes that are stacked in a different or same orientation, forming a fiber matrix. Examples of the fiber(s) include carbon fibers, glass fibers, aramid fibers (e.g., Kevlar), and/or other suitable fibers. Examples of the thermoplastic matrix include PP, PA, polyetheretherketone (PEEK), polycarbonate (PC), and/or other suitable matrices.

In some embodiments, the organo sheets 204a-b include multiple layers, each layer generally having a thickness of 0.1 mm to 0.3 mm. In various embodiments, each of the layers can have one or more fills (e.g., glass fill, resin fill, carbon fiber fill, etc.), and can differ in impregnation resins, providing unique properties to different layers. In various embodiments, the first organo sheet 204a and/or the second organo sheet 204b have a thickness of 0.05 mm to 3.5 mm (e.g., 0.06 mm to 3.4 mm, 0.07 mm to 3.3 mm, or 0.08 mm to 3.2 mm). In certain embodiments, the thickness of the first organo sheet 204a may be the same as, or different from, the thickness of the second organo sheet 204b.

The first organo sheet 204a includes a first section 210a, a second section 210b, a third section 210c, and a fourth section 210d (sections 210a-d). The sections 210a-d of the first organo sheet 204a are configured to be bonded to (or coupled with) the first side 205a of the composite base 202, for example, as described with respect to FIG. 2B. That is, an inner side 207 of the sections 210a-d bonds with the first side 205a of the composite base 202 (shown in FIG. 2C).

The second organo sheet 204b also includes a first section 212a, a second section 212b, a third section 212c, and a fourth section 212d (sections 212a-d). The sections 212a-d of the second organo sheet 204b are configured to bond with the second side 205b of the composite base 202, for example, in a manner similar to the first organo sheet 204a. That is, an inner side 209 of the sections 212a-d bonds with the second side 205b of the composite base 202 (shown in FIG. 2D).

In certain embodiments, one or more outer layers are disposed over an outer side 213 of the first organo sheet 204a and/or an outer side 215 the second organo sheet 204b. For example, a first outer layer can be formed over the outer side 213 of the first organo sheet 204a, and a second outer layer can be formed over the outer side 215 of the second organo sheet 204b. An example of an outer layer is described in further detail with respect to FIG. 2B.

FIG. 2B shows a cross-sectional side view of the first organo sheet 204a of the vehicle protection assembly 200 being bonded (or molded) to the composite base 202, according to certain embodiments.

To bond the first organo sheet 204a to the composite base 202, a heat press 216 is pressed against an outer layer 214. The outer layer 214 is disposed over the first organo sheet 204a, such that the first organo sheet 204a is disposed between the outer layer 214 and the composite base 202. In various embodiments, the outer layer 214 is made of a material that has a higher melting point than the first organo sheet 204a (e.g., polyethylene terephthalate (PET) or polyamide 66 (PA66)), but still allows for heat to transfer through conduction. The higher melting point of the outer layer 214 reduces the degree to which the heat press 216 sticks to the outer layer 214. As an example, a melting point of the outer layer 214 is at least 50 degrees Celsius (°C) greater than a melting point of the first organo sheet 204a.

In some embodiments, when a thickness of the first organo sheet 204a is less than 2 mm, a thickness of the outer layer 214 is greater than or equal to 25 microns. In other embodiments, when a thickness of the first organo sheet 204a is from 2 mm to 4 mm (e.g., 2.1 mm to 3.9 mm, 2.2 mm to 3.8 mm, or 2.3 and 3.7 mm), the thickness of the outer layer 214 is greater than or equal to 50 microns.

The heat press 216 can be operated at a temperature of 200° C to 230° C (e.g., 202° C to 228° C, 204° C to 226° C, or 206° C to 224° C). When the heat press 216 is pressed against the outer layer 214, the heat press 216 heats the outer layer 214 and the first organo sheet 204a, causing the first organo sheet 204a to bond with the composite base 202. In other words, the heat from the heat press 216 causes the first organo sheet 204a to at least partially melt over the reinforcement structures 208 and onto the first side 205a of the composite base 202. A similar bonding technique may also be implemented to bond the second organo sheet 204b to the second side 205b of the composite base.

Using the bonding technique described with respect to FIG. 2B allows flat organo sheets to be used as the organo sheets 204a-b (without pre-processing). Bonding the organo sheets 204a-b to the composite base 202 also prevents delamination of the organo sheets 204a-b from the composite base 202. Further, bonding the organo sheets 204a-b eliminates the need for an adhesive to hold the organo sheets 204a-b to the composite base 202, and eliminates the need for compression limiters and/or collars, which reduces costs associated with manufacturing the vehicle protection assembly 200.

Bonding the organo sheets 204a-b to the composite base 202 also improves the mechanical performance of the vehicle protection assembly 200. For example, the organo sheets 204a-b reinforce the composite base 202 by allowing loads to be distributed across a larger area, and by resisting bending or deformation due to the resulting vehicle protection assembly 200 having greater sectional inertia. In other words, the organo sheets 204a-b carry tensile loads, resist cracking and/or fatigue, and can absorb and dissipate energy more effectively than the composite base 202 alone.

FIGS. 2C-2D show different isometric perspective views of the vehicle protection assembly 200 shown in FIG. 2A, according to certain embodiments. For example, FIG. 2C shows an isometric perspective view of a top side 203a of the vehicle protection assembly 200, and FIG. 2D shows an isometric perspective view of a bottom side 203b of the vehicle protection assembly 200. Thus, FIGS. 2C-2D are described together herein for clarity purposes.

As shown in FIGS. 2C-2D, the vehicle protection assembly 200 includes a first module 201a, a second module 201b, a third module 201c, and a fourth module 201d (modules 201a-d). The modules 201a-d may also be referred to herein as “regions” of the vehicle protection assembly 200. Each of the modules 201a-d includes corresponding sections of the organo sheets 204a-b. For example, the first module 201a includes the first section 210a of the first organo sheet 204a and the first section 212a of the second organo sheet 204b, the second module 201b includes the second section 210b of the first organo sheet 204a and the second section 212b of the second organo sheet 204b, and so forth.

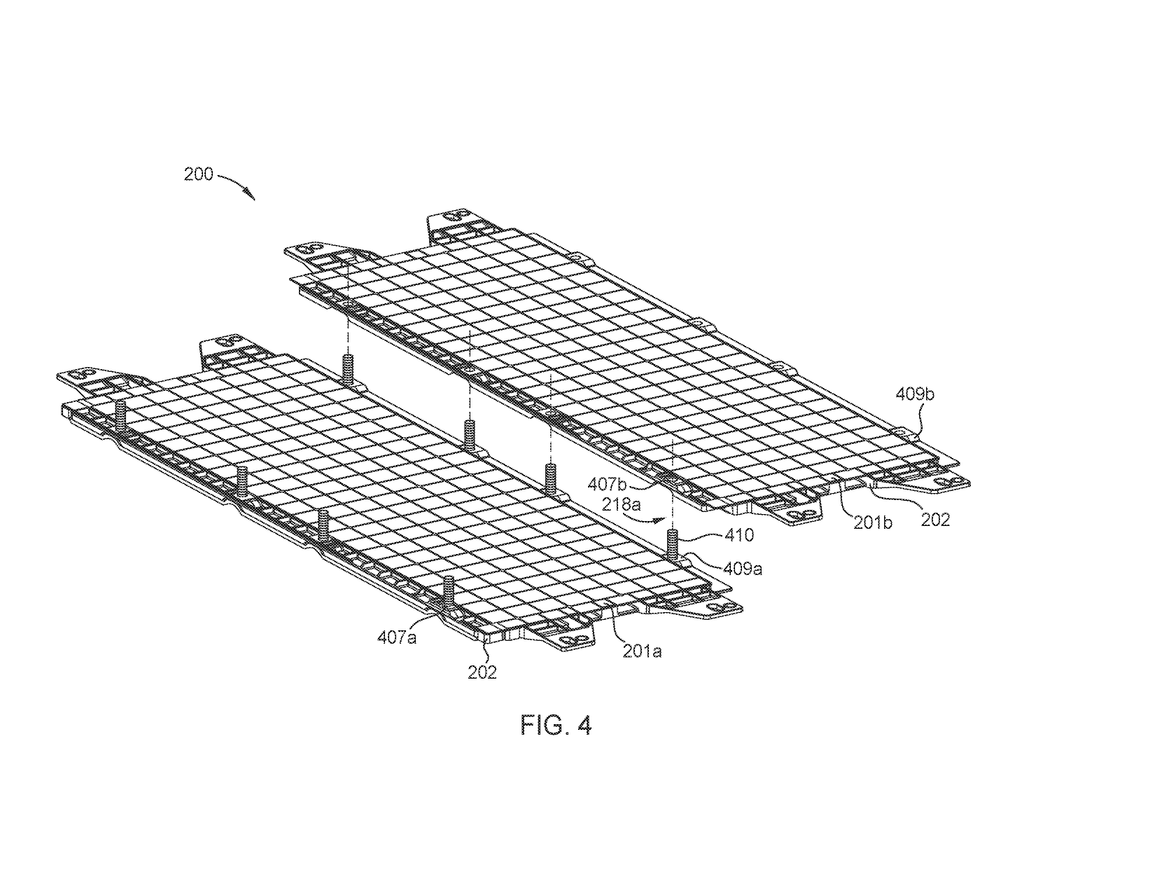

In some embodiments, the composite base 202 is made of a singular body, such that each of the modules 201a-d further includes a corresponding portion of the singular body of the composite base 202. In another embodiment, the composite base 202 is a multi-piece body, such that the composite base 202 is made of a plurality of sections similar to the organo sheets 204a-b, and each of the modules 201a-d further includes a corresponding section of the multi-piece body of the composite base 202. An example where the composite base 202 is a multi-piece body is described in further detail with respect to FIG. 4.

As shown in FIGS. 2C-2D, each of the modules 201a-d includes a plurality of brackets. For example, the first module 201a includes a first bracket 220a, a second bracket 220b, a third bracket 220c, and a fourth bracket 220d (brackets 220a-d). The first bracket 220a and the second bracket 220b are disposed on one side of the first module 201a, while the third bracket 220c and the fourth bracket 220d are disposed on an opposite side of the first module 201a. The brackets 220a-d extend laterally outwards from the composite base 202 and allow the vehicle protection assembly 200 to be coupled to the underside 130 of a vehicle chassis (e.g., the chassis 106 shown in FIG. 1B). Although not labeled, modules 201b, 201c, and 201d also include brackets similar to the first module 201a.

As shown in FIG. 2D, the first module 201a is coupled with the second module 201b by a first coupling feature 218a, a second coupling feature 218b, a third coupling feature 218c, and a fourth coupling feature 218d (coupling features 218a-d). In some embodiments, when the composite base 202 is a singular body, the coupling features 218a-d couple the first section 212a with the second section 212b of the second organo sheet 204b. In another embodiment, when the composite base 202 is a multi-piece body, the coupling features 218a-d couple the first and second sections of the composite base 202, as well as the first and second sections 212a, 212b of the second organo sheet 204b. The coupling features 218a-d are described in further detail with respect to FIG. 4.

In some embodiments, the composite base 202, the first organo sheet 204a, and/or the second organo sheet 204b may have a different thickness in each of the modules 201a-d. As an example, for the first module 201a, the corresponding section of the composite base 202 can have a thickness of 3 mm, the first section 210a of the first organo sheet 204a can have a thickness of 1.5 mm, and the first section 212a of the second organo sheet 204b can have a thickness of 2 mm. As another example, for the second module 201b, the corresponding section of the composite base 202 can have a thickness of 4 mm, the second section 210b of the first organo sheet 204a can have a thickness of 1 mm, and the second section 212b of the second organo sheet 204b can have a thickness of 1 mm.

In some embodiments, each of the modules 201a-d may have a different glass charge, glass fill, or glass type for the first organo sheet 204a and/or the second organo sheet 204b. As an example, for the first module 201a, the first section 210a of the first organo sheet 204a can have a glass charge of 20%. As another example, for the second module 201b, the second section 210b of the first organo sheet 204a can have a glass charge of 10%. As yet another example, for the fourth module 201d, the fourth section 210d of the first organo sheet 204a can have a glass charge of 30%. Other glass charges are also contemplated.

In certain embodiments, the vehicle protection assembly 200 further includes one or more drain channels formed in the composite base 202 and/or the second organo sheet 204b. For example, the drain channel(s) can be formed on the second side 205b of the composite base 202 and/or the inner side 209 of the second organo sheet 204b. The drain channel(s) may be disposed longitudinally and are configured to prevent fluid from remaining within the vehicle protection assembly 200.

In certain embodiments, the vehicle protection assembly 200 further includes one or more drain apertures formed in the composite base 202, the first organo sheet 204a, and/or the second organo sheet 204b. For example, the drain aperture(s) can be formed through portions of the composite base 202, the first organo sheet 204a, and/or the second organo sheet 204b. The drain aperture(s) are configured to prevent fluid from remaining within the vehicle protection assembly 200.

Integrating the drain channel(s) and/or the drain aperture(s) into the vehicle protection assembly 200 protects against corrosion. For example, the drain channel(s) and/or the drain aperture(s) protect against the creation of galvanic corrosion cells by ensuring fluid and/or poultice is removed from the vehicle protection assembly 200. In certain embodiments, the drain channel(s) and/or the drain aperture(s) drain fluid and/or poultice from the vehicle protection assembly 200 similar to a sieve.

Further, although the vehicle protection assembly 200 is shown in FIGS. 2A and 2C-2D as including four modules 201a-d, the vehicle protection assembly 200 may also include less than or more than four modules. In certain embodiments, the modules 201a-d can also be made of multiple layers of steel that are spot welded together. For example, the modules 201a-d may include three layers of steel instead of the composite base 202 and the organo sheets 204a-b.

FIG. 3A shows a top view of the composite base 202 shown in FIG. 2A with reinforcement structures 208 having different geometric arrangements, according to certain embodiments. The first organo sheet 204a is not shown in FIG. 3A for clarity purposes.

As shown in FIG. 3A, the reinforcement structures 208 of the first module 201a have a linear geometry, such that the reinforcement structures 208 include a plurality of ribs 302 disposed laterally across the first module 201a. The reinforcement structures 208 of the second module 201b and the third module 201c have a hexagonal geometry, such that the reinforcement structures 208 include a plurality of honeycomb-shaped ribs 304 disposed across the second module 201b and the third module 201c. The reinforcement structures 208 of the fourth module 201d have a grid-like geometry, such that the reinforcement structures 208 include a plurality of square ribs 306 disposed across the fourth module 201d.

Generally, the square ribs 306 in the fourth module 201d provide greater stiffness (or strength) than the ribs 302 and the honeycomb-shaped ribs 304. Conversely, the honeycomb-shaped ribs 304 provide less stiffness than the ribs 302 and the square ribs 306.

In certain embodiments, the geometric arrangements of the reinforcement structures 208 for each of the modules 201a-d is based on potential external impact to the vehicle protection assembly 200. For example, the first module 201a may be disposed towards the front of the chassis 106 near two front wheel modules 107, while the fourth module 201d may be disposed towards the back of the chassis 106 near the two rear wheel modules 107, and the second and third modules 201b, 201c may be disposed between the front and rear wheel modules 107. As such, because the potential external impact is greatest by the two rear wheel modules 107, and lowest between the front and rear wheel modules 107, the modules 201a-d may have the geometric arrangements as shown in FIG. 3A.

FIG. 3B shows a top view of the composite base 202 shown in FIG. 2A with reinforcement structures 208 having different densities, according to certain embodiments. Each of the modules 201a-d is shown as having the linear geometry including the ribs 302, but may also include the honeycomb-shaped ribs 304, the square ribs 306, or a combination thereof. Additionally, the first organo sheet 204a is not shown in FIG. 3B for clarity purposes.

The reinforcement structures 208 of the first module 201a have a medium density 308, such that each of the ribs 302 in the first module 201a are separated by a distance of at least 35 mm. The reinforcement structures 208 of the second and third modules 201b, 201c have a low density 310, such that each of the ribs 302 in the second and third modules 201b, 201c are separated by a distance of at least 40 mm. The reinforcement structures 208 of the fourth module 201d have a high density 312, such that each of the ribs 302 in the fourth module 201d are separated by a distance of at least 30 mm. Although certain separation distances are provided for the different densities 308, 310, and 312, other distances are also contemplated.

Generally, the high density 312 of the reinforcement structures 208 in the fourth module 201d provides greater stiffness (or strength) than the medium density 308 and the low density 310. Conversely, the low density 310 of the reinforcement structures 208 in the second and third modules 201b, 201c provides less stiffness than the medium density 308 and the high density 312.

Similar to the geometric arrangements described with respect to FIG. 3A, the density of the reinforcement structures 208 for each of the modules 201a-d is based on potential external impact to the vehicle protection assembly 200. As such, because the potential external impact is greatest near the two rear wheel modules 107, and lowest between the front and rear wheel modules 107, the modules 201a-d may have the corresponding densities 308, 310, and 312 shown in FIG. 3B.

FIG. 3C shows a top view of the composite base 202 shown in FIG. 2A with reinforcement structures 208 having different thicknesses, according to certain embodiments. Each of the modules 201a-d is shown as having the linear geometry including the ribs 302, but may also include the honeycomb-shaped ribs 304, the square ribs 306, or a combination thereof. Additionally, the first organo sheet 204a is not shown in FIG. 3C for clarity purposes.

The reinforcement structures 208 of the first module 201a have a medium thickness 314, such that each of the ribs 302 in the first module 201a has a thickness of 3.5 mm to 4.0 mm (e.g., 3.6 mm to 3.9 mm or 3.7 mm to 3.8). The reinforcement structures 208 of the second and third modules 201b, 201c have a low thickness 316, such that each of the ribs 302 in the second and third modules 201b, 201c has a thickness of 2.8 mm to 3.5 mm (e.g., 2.9 mm to 3.4 mm, 3.0 mm to 3.3 mm, or 3.1 mm to 3.2 mm). The reinforcement structures 208 of the fourth module 201d have a high thickness 318, such that each of the ribs 302 in the fourth module 301d has a thickness of 4.0 mm to 5.5 mm (e.g., 4.1 mm to 5.4 mm, 4.2 mm to 5.3 mm, or 4.3 mm to 5.2 mm). Although certain ranges are provided for the different thicknesses 314, 316, and 318, other ranges are also contemplated.

Generally, the high thickness 318 of the reinforcement structures 208 in the fourth module 201d provides greater stiffness (or strength) than the medium thickness 314 and the low thickness 316. Conversely, the low thickness 316 of the reinforcement structures 208 in the second and third modules 201b, 201c provides less stiffness than the medium thickness 314 and the high thickness 318.

Similar to the geometric arrangements described with respect to FIG. 3A, the thickness of the reinforcement structures 208 for each of the modules 201a-d is based on potential external impact to the vehicle protection assembly 200. As such, because the potential external impact is greatest near the two rear wheel modules 107, and lowest between the front and rear wheel modules 107, the modules 201a-d may have the corresponding densities 308, 310, and 312 shown in FIG. 3C.

Although the reinforcement structures 208 for each of the modules 201a-d are shown as having a corresponding geometric arrangement, density, and thickness, the reinforcement structures 208 of the modules 201a-d may have any combination of different geometric arrangements, densities, and/or thicknesses.

FIG. 4 shows an exploded isometric perspective view of modules of the vehicle protection assembly 200 shown in FIGS. 2C-2D, according to certain embodiments. In FIG. 4, the composite base 202 is made of a multi-piece body, such that the first module 201a can be separated from the second module 201b.

The first module 201a includes a first receiving portion 407a and a first protruding portion 409a. Similarly, the second module 201b includes a second receiving portion 407b and a second protruding portion 409b. As an example, the second receiving portion 407b of the second module 201b is configured to receive the first protruding portion 409a of the first module 201a. Thus, to form the first coupling feature 218a, the first protruding portion 409a of the second module 201b is mated with the second receiving portion 407b of the second module 201b. A bolt 410 can be used to secure the first and second modules 201a, 201b together, but the first and second modules 201a, 201b can also be secured together via a snap-fit or other suitable securing mechanism.

Although not labeled, the first and second modules 201a, 201b include additional receiving portions and protruding portions similar to the first and second receiving portions 407a, 407b and the first and second protruding portions 409a, 409b. In certain embodiments, the third and fourth modules 201c, 201d, may also each include protruding portions and receiving portions similar to the first and second modules 201a, 201b. Thus, a similar coupling mechanism may be used to couple the third module 201c with the second module 201b, and the fourth module 201d with the third module 201c.

The modularity of the vehicle protection assembly 200 described with respect to FIG. 4 reduces press tonnage when manufacturing the modules 201a-d. For example, the tonnage needed by a press to manufacture each of the modules 201a-d individually (e.g., in a multi-piece body embodiment) may be less than the tonnage needed by the press to manufacture the modules 201a-d collectively (e.g., in a singular body embodiment), which reduces manufacturing costs. The modularity of the vehicle protection assembly 200 also allows for the individual servicing of each of the modules 201a-d. In other words, when one or more of the modules 201a-d has been damaged or needs to be replaced, the module(s) 201a-d can be serviced independently from one another, without having to replace the entire vehicle protection assembly 200. Such serviceability further reduces risks and labor associated with replacing the module(s) 201a-d.

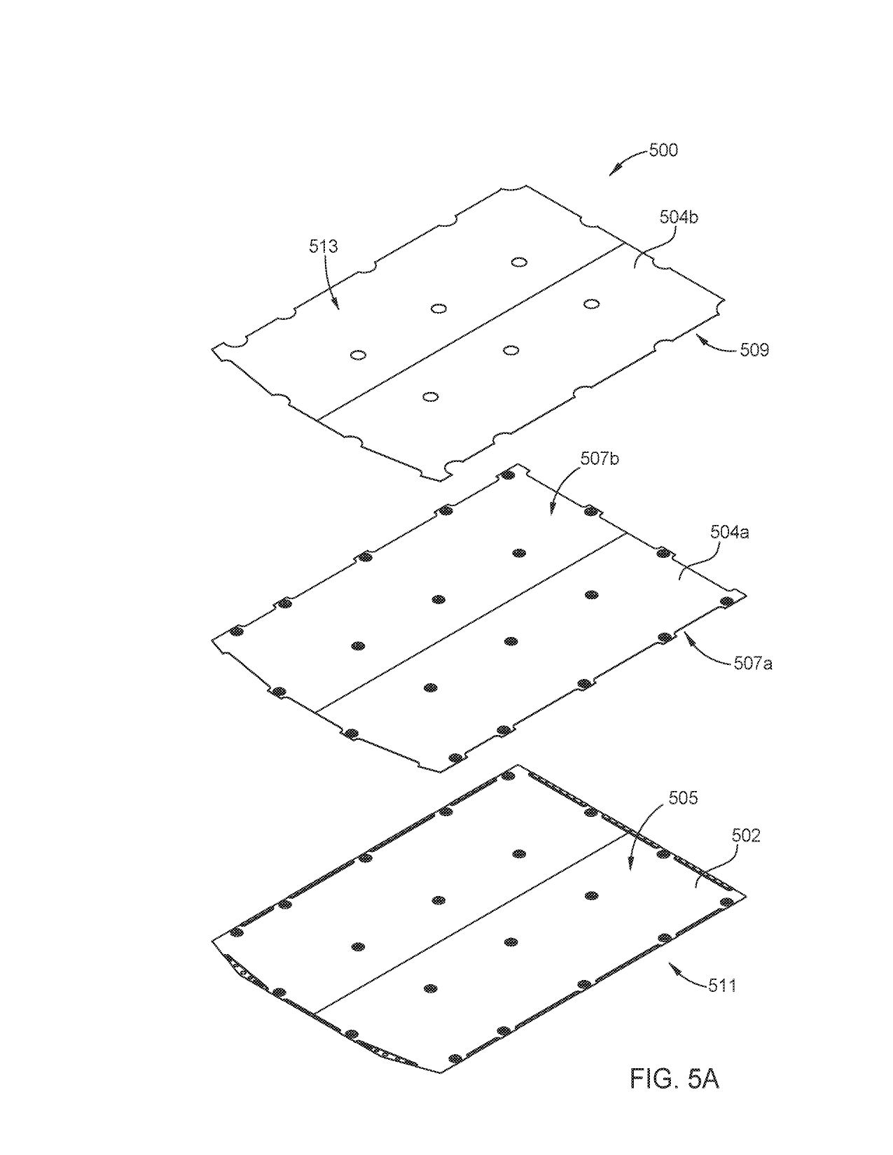

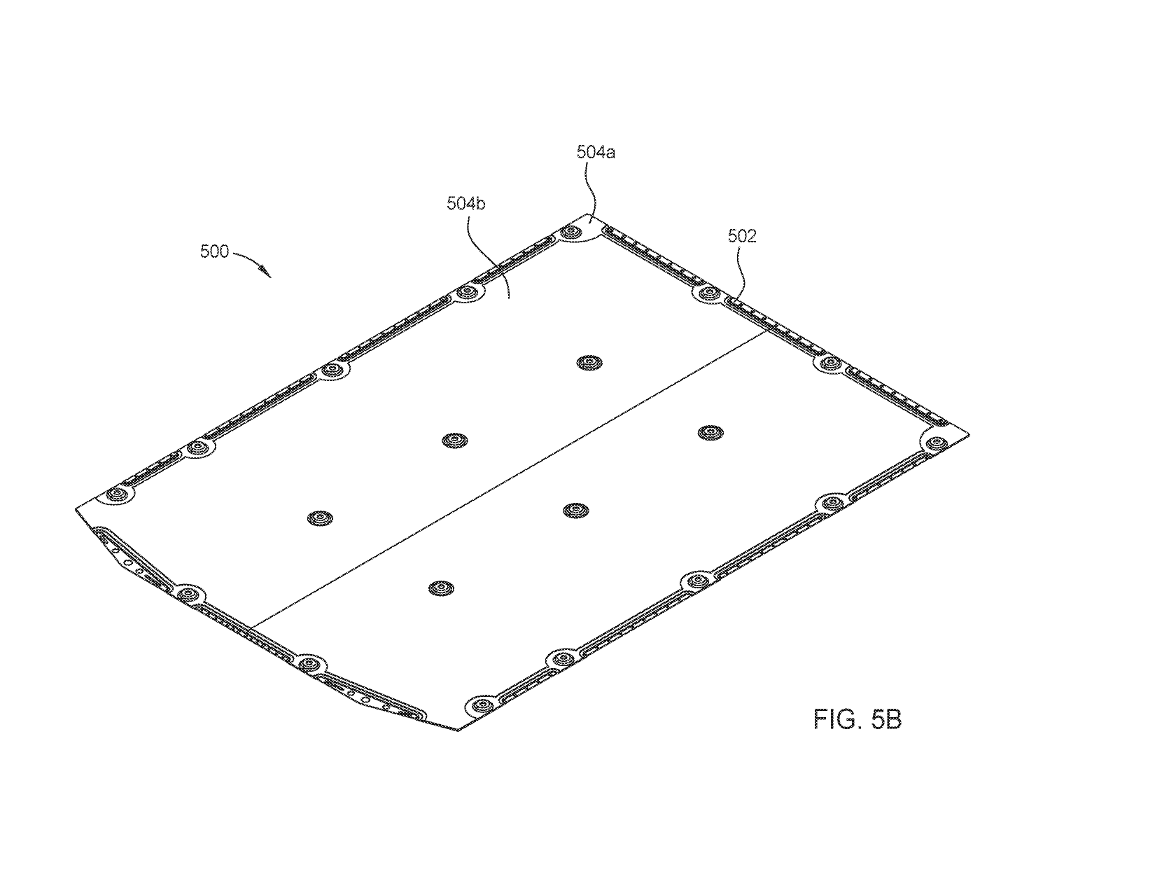

FIGS. 5A-5B show different views of a stack 500 of another example vehicle protection assembly for the underside 130 of the chassis 106 shown in FIG. 1B, according to certain embodiments. For example, FIG. 5A shows an exploded view of the stack 500, and FIG. 5B shows an isometric perspective view of the stack 500 shown in FIG. 5A. Thus, FIGS. 5A-5B are described together herein for clarity purposes.

The stack 500 shown in FIGS. 5A-5B includes an aluminum base 502 as well as a first organo sheet 504a and a second organo sheet 504b (organo sheets 504a-b).

As shown in FIG. 5A, the aluminum base 502 includes an inner side 505 that faces the first organo sheet 504a, and an outer side 511. The aluminum base 502 is generally made of one or more metallic alloys (e.g., aluminum alloy, silicon alloy, magnesium alloy, copper alloy, zinc alloy, etc.). In various embodiments, the aluminum base 502 has a thickness of 1.0 mm to 2.0 mm (e.g., 1.1 mm to 1.9 mm, 1.2 mm to 1.8 mm, or 1.3 mm to 1.7 mm). In certain embodiments, the thickness of the aluminum base 502 is greater than a thickness of the first organo sheet 504a and a thickness of the second organo sheet 504b.

The organo sheets 504a-b are generally made of a combination of one or more fibers and a thermoplastic matrix, for example, similar to the organo sheets 204a-b described with respect to FIG. 2A. In various embodiments, the first organo sheet 204a and/or the second organo sheet 504b have a thickness of 0.05 mm to 3.5 mm (e.g., 0.06 mm to 3.4 mm, 0.07 mm to 3.3 mm, or 0.08 mm to 3.2 mm). In certain embodiments, the thickness of the first organo sheet 504a may be the same as, or different from the thickness of the second organo sheet 504b.

The first organo sheet 504a includes a first side 507a and a second side 507b (sides 507a-b). The first side 507a faces the aluminum base 502 and the second side 507b, which is opposite the first side 507a, faces the second organo sheet 504b. The first side 507a of the first organo sheet 504a is configured to be coupled with the aluminum base 502, and the second side 507b of the first organo sheet 504a is configured to be coupled with the second organo sheet 504b, for example, as described with respect to FIG. 5B.

The second organo sheet 504b includes an inner side 509 that faces the first organo sheet 504a, and an outer side 513. The inner side 509 of the second organo sheet 504b is configured to be coupled with the second side 507b of the first organo sheet 504a. In certain embodiments, one or more outer layers are disposed over the outer side 513 of the second organo sheet 504b, for example, similar to the outer layer 214 described with respect to FIG. 5B.

In certain embodiments, to bond the first organo sheet 504a to the aluminum base 502, the stack 500 is placed in a heater. The heater can be operated at a temperature of 200° C to 230° C (e.g., 202° C to 228° C, 204° C to 226° C, or 206° C to 224° C). The heater heats the organo sheets 504a-b, causing the second organo sheet 504b to bond with the first organo sheet 504a, and the first organo sheet 504a to bond with the aluminum base 502. In other words, the heat from the heater causes the organo sheets 504a-b to at least partially melt and bond with each other, and causes the first organo sheet 504a to at least partially melt and bond to the aluminum base 502.

FIGS. 6A-6B show different isometric perspective views of an example vehicle protection assembly 600 including the stack 500 shown in FIGS. 5A-5B, according to certain embodiments. For example, FIG. 6A shows an isometric perspective view of a top side 605a of the vehicle protection assembly 600, and FIG. 6B shows an isometric perspective view of a bottom side 605b of the vehicle protection assembly 600. Thus, FIGS. 6A-6B are described together herein for clarity purposes.

As shown in FIGS. 6A-6B, the vehicle protection assembly 600 includes the stack 500, which includes the aluminum base 502 and organo sheets 504a-b, and an injection molded material 602. The vehicle protection assembly 600 further includes a plurality of bolt bearing apertures 606 (one labeled for clarity purposes). An example of bolt bearing aperture 606 is described in further detail with respect to FIGS. 7A-7D.

The injection molded material 602 is generally made of a thermoplastic material or other moldable composite material (e.g., a glass fiber-reinforced PP such as PPGF30). The injection molded material 602 is molded onto the stack 500 and bonds the second organo sheet 504b to the first organo sheet 504a. As such, the injection molded material 602 is disposed over at least a portion of the aluminum base 502, at least a portion of the first organo sheet 504a, and at least a portion of the second organo sheet 504b. At least a portion of the injection molded material 602 is also disposed across the second organo sheet 504b. For example, the injection molded material 602 includes a first portion 604a that extends across the second organo sheet 504b, and a second portion 604b that extends partially across the second organo sheet 504b.

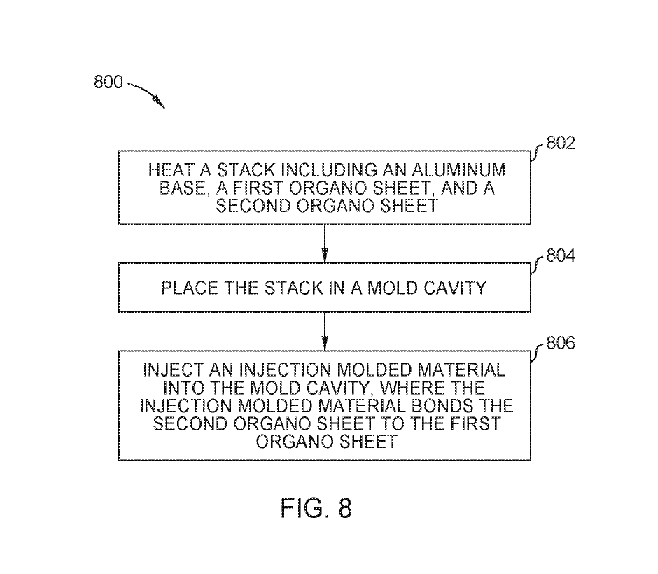

The injection molded material 602 can be molded onto the stack 500 by injecting the injection molded material 602 into a cavity holding the stack 500, for example, as described with respect to FIG. 8. The injection of the injection molded material 602 allows for lower press tonnage, which reduces manufacturing costs. Further, the injection of the injection molded material 602 allows for formation of small over-molded features, such as the portions 604a, 604b, which eliminates the need for certain post-processing operations. Injecting the injection molded material 602 into the cavity also improves glass fiber distribution across the vehicle protection assembly 600.

Although not labeled, the injection molded material 602 includes additional first and second portions 604a, 604b disposed at least partially over the second organo sheet 504b. The vehicle protection assembly 600 may also include a number and/or arrangement of first and second portions 604a, 604b that is different from that shown in FIGS. 6A-6B.

In certain embodiments, the vehicle protection assembly 600 further includes one or more drain channels formed in the aluminum base 502 and/or the first organo sheet 504a. For example, the drain channel(s) can be formed on the inner side 505 of the aluminum base 502 and/or the first side 507a of the first organo sheet 504a. The drain channel(s) may be disposed longitudinally and are configured to prevent fluid from remaining within the vehicle protection assembly 600 (e.g., similar to the drain channel(s) described with respect to vehicle protection assembly 200).

In certain embodiments, the vehicle protection assembly 200 further includes one or more drain apertures formed in the aluminum base 502, the first organo sheet 504a, and/or the second organo sheet 504b. For example, the drain aperture(s) can be formed through portions of the aluminum base 502, the first organo sheet 504a, and/or the second organo sheet 504b. The drain aperture(s) are configured to prevent fluid from remaining within the vehicle protection assembly 600 (e.g., similar to the drain aperture(s) described with respect to vehicle protection assembly 200).

FIG. 7A shows a magnified isometric perspective view of the vehicle protection assembly 600 shown in FIGS. 6A-6B, according to certain embodiments. As shown in FIG. 7A, the vehicle protection assembly 600 includes the aluminum base 502, the organo sheets 504a-b, and the bolt bearing aperture 606, which is formed as part of a bolt bearing cone 710. Additionally, the aluminum base 502 is shown as including a flange 712 and a plurality of anchor bores 714 (one labeled for clarity purposes), with which the injection molded material 602 interfaces to secure the injection molded material 602 to the vehicle protection assembly 600. The injection molded material 602 is not shown as part of the vehicle protection assembly 600 in FIG. 7A for clarity purposes, but is shown in FIGS. 7B-7D.

FIGS. 7B-7D show different isometric cross-sectional views of the vehicle protection assembly 600 shown in FIG. 7A, according to certain embodiments. For example, FIG. 7B shows the 7B-7B cross section of FIG. 7A, FIG. 7C shows the 7C-7C cross section of FIG. 7A, and FIG. 7D shows the 7D-7D cross section of FIG. 7A.

As shown in FIG. 7B, the bolt bearing aperture 606 is defined by an opening disposed through at least a portion of the aluminum base 502 and at least a portion of the first organo sheet 504a. Defining the bolt bearing aperture 606 by portions of the aluminum base 502 and the first organo sheet 504a minimizes creep by the injection molded material 602 at the bolt bearing aperture 606 because the first organo sheet 504a holds residual torques better than the injection molded material 602. The first organo sheet 504a at the bolt bearing aperture 606 also eliminates the need for a compression limiter, which reduces manufacturing costs.

The bolt bearing cone 710 is defined by a partially conical protrusion that includes at least a portion of the aluminum base 502, at least a portion of the first organo sheet 504a, and at least a portion of the injection molded material 602. The injection molded material 602 is also formed over the first organo sheet 504a and the second organo sheet 504b, which bonds (or locks) the organo sheets 504a-b to each other, and to the aluminum base 502. The second portion 604b of the injection molded material 602 is also shown in FIG. 7B as being disposed over the second organo sheet 504b. Forming the injection molded material 602 over the aluminum base 502 and the organo sheets 504a-b eliminates the need for an adhesive to bond the layers together and prevents delamination of one or more of the organo sheets 504a-b from the vehicle protection assembly 600.

As shown in FIG. 7C, the injection molded material 602 is formed over the flange 712 of the aluminum base 502. The aluminum base 502 is undercut such that the injection molded material 602 is disposed over the flange 712, and at least partially over the inner side 505 and the outer side 511 of the aluminum base 502. By forming the injection molded material 602 over the flange 712 of the aluminum base 502, the injection molded material 602 prevents the aluminum base 502 from being displaced relative to the injection molded material 602. In other words, the injection molded material 602 secures to the flange 712, providing resistance to shear, tension, and/or pull-out forces.

As shown in FIG. 7D, the injection molded material 602 fills the anchor bore 714. In other words, the injection molded material 602 is disposed through (or occupies) the anchor bore 714, creating a closed loop around the flange 712 of the aluminum base 502. By filling the anchor bore 714, the injection molded material 602 is secured to the aluminum base 502 via an interlocking mechanism, which prevents the injection molded material 602 from separating or breaking away from the aluminum base 502. Thus, the injection molded material 602 serves as a mechanical anchor, creating a secure bond with the aluminum base 502 and eliminating the need for additional fasteners and/or adhesives.

FIG. 8 is a flow diagram of a technique 800 for manufacturing a vehicle protection assembly, according to certain embodiments. As an example, the technique 800 may be used to manufacture the vehicle protection assembly 600 described with respect to FIGS. 6A-6B and 7A-7D.

At operation 802, the stack 500 shown in FIGS. 5A-5B, which includes the aluminum base 502, the first organo sheet 504a, and the second organo sheet 504b, is heated. The stack 500 may be heated in a heater (e.g., an oven). In certain embodiments, the stack 500 is heated until the stack 500 reaches a temperature of 150 °C to 250 °C (e.g., 160° C to 240 °C, 170° C to 230° C, or 180° C to 220° C).

At operation 804, the stack 500 is placed in a mold cavity. As an example, the mold cavity forms an area around and/or over the stack 500 into which an injection molded material (e.g., injection molded material 602) can be injected. Accordingly, the cavity determines a shape and structure of the injection molded material 602.

At operation 806, the injection molded material 602 shown in FIGS. 6A-6B is injected into the mold cavity. The injection molded material 602 bonds the second organo sheet 504b to the first organo sheet 504a, and may also bond the organo sheets 504a-b to the aluminum base 502.

In certain embodiments, after the operation 806, a plurality of holes are optionally drilled through the aluminum base 502, the first organo sheet 504a, and the second organo sheet 504b, and the injection molded material 602. The plurality of holes form the bolt bearing apertures 606 shown in FIGS. 6A-6B.

In certain embodiments, before the stack 500 is heated at the operation 802, a plurality of bores (e.g., anchor bore 714 shown in FIG. 7A) are optionally drilled in the aluminum base 502, and the aluminum base 502 is undercut. By forming the bores and undercutting the aluminum base 502, the aluminum base 502 is locked with the injection molded material 602 after the injection molded material 602 is injected into the cavity at the operation 806, for example, as described with respect to FIGS. 7A-7D.

The present disclosure may be embodied in other specific forms without departing from its spirit. The described embodiments are to be considered in all respects only as illustrative and not restrictive. The scope of the present disclosure is, therefore, indicated by the appended Claims rather than by this Detailed Description. All changes which come within the meaning and range of equivalency of the Claims are to be embraced within their scope.

Reference throughout this specification to features, advantages, or similar language does not imply that all the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the present disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

The foregoing description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein but are to be accorded the full scope consistent with the language of the claims.

What is claimed is:

1. A vehicle protection assembly, comprising:
a composite base having a first side and a second side that is opposite the first side;
a first organo sheet bonded to the first side of the composite base; and
a second organo sheet bonded to the second side of the composite base.

2. The vehicle protection assembly of claim 1, wherein the first side of the composite base comprises a plurality of regions each having a plurality of reinforcement structures.

3. The vehicle protection assembly of claim 2, wherein the plurality of reinforcement structures have different geometric arrangements in at least two of the plurality of regions.

4. The vehicle protection assembly of claim 2, wherein the plurality of reinforcement structures have different densities in at least two of the plurality of regions.

5. The vehicle protection assembly of claim 2, wherein the plurality of reinforcement structures have different thicknesses in at least two of the plurality of regions.

6. The vehicle protection assembly of claim 1, further comprising:
a plurality of drain apertures formed through the composite base, the first organo sheet, and the second organo sheet.

7. The vehicle protection assembly of claim 1, further comprising:
an outer layer,
wherein the first organo sheet is disposed between the outer layer and the composite base.

8. The vehicle protection assembly of claim 1, wherein the vehicle protection assembly comprises a plurality of modules, each module included in the plurality of modules comprising:
at least one section of the composite base that is separate from a section of the composite base in at least one other module;
at least one section of the first organo sheet that is separate from a section of the first organo sheet in at least one other module; and
at least one section of the second organo sheet that is separate from a section of the second organo sheet in at least one other module.

9. The vehicle protection assembly of claim 1, wherein a thickness of the composite base is greater than a thickness of the first organo sheet and a thickness of the second organo sheet.

10. The vehicle protection assembly of claim 1, wherein:
the composite base comprises a thermoplastic polymer; and
the first organo sheet and the second organo sheet comprise at least one of a woven thermoplastic polymer or a laminated thermoplastic polymer.

11. The vehicle protection assembly of claim 1, wherein the vehicle protection assembly comprises an underbody component.

12. The vehicle protection assembly of claim 1, wherein the vehicle protection assembly comprises a skid plate.

13. A vehicle protection assembly, comprising:
an aluminum base;
a first organo sheet having a first side and a second side, the first side of the first organo sheet coupled to the aluminum base;
a second organo sheet coupled to the second side of the first organo sheet; and
an injection molded material bonding the second organo sheet to the first organo sheet.

14. The vehicle protection assembly of claim 13, wherein the injection molded material is disposed over at least a portion of the aluminum base, at least a portion of the first organo sheet, and at least a portion of the second organo sheet.

15. The vehicle protection assembly of claim 13, wherein at least a portion of the injection molded material is disposed across the second organo sheet.

16. The vehicle protection assembly of claim 13, further comprising:
a plurality of bolt bearing apertures defined by:
at least a portion of the aluminum base; and
at least a portion of the first organo sheet.

17. The vehicle protection assembly of claim 13, further comprising:
a plurality of bolt bearing cones defined by:
at least a portion of the aluminum base;
at least a portion of the first organo sheet; and
at least a portion of the injection molded material.

18. A method of manufacturing a vehicle protection assembly, comprising:
heating a stack comprised of an aluminum base, a first organo sheet, and a second organo sheet;
placing the stack in a mold cavity; and
injecting an injection molded material into the mold cavity, wherein the injection molded material bonds the second organo sheet to the first organo sheet.

19. The method of claim 18, further comprising:
forming a plurality of holes through the aluminum base, the first organo sheet, the second organo sheet, and the injection molded material.

20. The method of claim 18, further comprising:
undercutting the aluminum base to lock the aluminum base with the injection molded material.
